(19) United States
(12) Patent Application Publication
(10) Pub. No.: US 2018/0001486 A1
(43) Pub. Date: Jan. 4, 2018

(54) ROBOT, ROBOT CONTROL DEVICE, AND ROBOT SYSTEM

(71) Applicant: Seiko Epson Corporation, Tokyo (JP)

(72) Inventors: Shunsuke TOSHIMITSU, Azumino (JP); Katsuji IGARASHI, Chino (JP)

(21) Appl. No.: 15/635,518

(22) Filed: Jun. 28, 2017

(30) Foreign Application Priority Data
Jun. 29, 2016 (JP) 2016-129171

(51) Int. Cl. B25J 18/04; B25J 15/08; B25J 9/00

(52) U.S. Cl. CPC B25J 18/04; B25J 9/0018; B25J 15/08

(57) ABSTRACT

A robot includes a manipulator including an n (n is an integer equal to or larger than 1)-th member capable of turning around an n-th turning axis, an (n+1)-th member provided in the n-th member to be capable of turning around an (n+1)-th turning axis having an axial direction different from an axial direction of the n-th turning axis, and an (n+2)-th member turnably provided in the (n+1)-th member. The n-th member and the (n+1)-th member are capable of overlapping each other when viewed from an axial direction of the (n+1)-th turning axis. A specific portion of the (n+2) -th member does not intrude into an inside of a first region including a turning center on the (n+1)-th turning axis. The first region includes a singular point of the manipulator and an immovable region of the manipulator.

### BACKGROUND

### 1. Technical Field

The present invention relates to a robot, a robot control device, and a robot system.

### 2. Related Art

There is known a robot including a base and a manipulator including a plurality of arms (links). One arm of adjacent two arms of the manipulator is turnably coupled to the other arm via a joint section. An arm at a most proximal end side (a most upstream side) is turnably coupled to the base via a joint section. The joint sections are driven by motors. The arms turn according to the driving of the joint sections. For example, a hand is detachably attached to an arm on a most distal end side (a most downstream side) as an end effector. For example, the robot grips a target object with the hand, moves the target object to a predetermined place, and performs predetermined work such as assembly.

As such a robot, JP-A-2016-68226 (Patent Literature 1) discloses a vertical multi-joint robot including a base and a manipulator including six arms. In the robot, a first arm and a second arm are capable of overlapping each other when viewed from the axial direction of a second turning axis, which is a turning axis of the second arm. Therefore, it is possible to reduce a space for preventing the robot from interfering with the distal end of the manipulator when the distal end of the manipulator is turned 180° around a first turning axis, which is a turning axis of the first arm.

However, in the robot described in Patent Literature 1, when a CP operation is performed in the predetermined work, a singular point is not taken into account. When a predetermined portion of the manipulator is about to pass the singular point, an error occurs and the robot urgently stops. That is, the robot suspends work because of an unexpected error or the like.

### SUMMARY

An advantage of some aspects of the invention is to solve at least a part of the problems described above, and the invention can be implemented as the following forms or application examples.

A robot according to an aspect of the invention includes a manipulator including an n (n is an integer equal to or larger than 1)-th member capable of turning around an n-th turning axis, an (n+1)-th member provided in the n-th member to be capable of turning around an (n+1)-th turning axis having an axial direction different from an axial direction of the n-th turning axis, and an (n+2)-th member turnably provided in the (n+1)-th member. The n-th member and the (n+1)-th member are capable of overlapping each other when viewed from an axial direction of the (n+1)-th turning axis. A specific portion of the (n+2) -th member does not intrude into an inside of a first region including a turning center on the (n+1)-th turning axis. The first region includes a singular point of the manipulator and an immovable region of the manipulator.

When the specific portion of the (n+2)-th member is about to pass the singular point, in the related art, an error occurs immediately before the specific portion passes the singular point. The robot urgently stops. On the other hand, in the aspect of the invention, it is possible to suppress the error that occurs when the specific portion of the (n+2)-th member is about to pass the singular point.

It is possible to reduce a space for preventing the robot from interfering with the distal end of the manipulator when the distal end of the manipulator is turned 180° around the n-th turning axis.

In the robot according to the aspect, it is preferable that a shape of the first region is a circle when viewed from the axial direction of the (n+1)-th turning axis.

With this configuration, it is possible to smoothly operate the manipulator when operating the manipulator while preventing the specific portion of the (n+2)-th member from intruding into the inside of the first region.

In the robot according to the aspect, it is preferable that a contour of the first region is a singular region including the singular point.

With this configuration, it is possible to suppress the error in the related art that occurs when the specific portion of the (n+2)-th member is about to pass the singular point.

In the robot according to the aspect, it is preferable that the inside of the first region is the immovable region.

With this configuration, it is possible to suppress the error in the related art that occurs when the specific portion of the (n+2)-th member is about to pass the singular point.

In the robot according to the aspect, it is preferable that a second region is set on an outside of the first region, and, when the specific portion intrudes into an inside of the second region, the manipulator operates while preventing the specific portion from intruding into the inside of the first region.

With this configuration, by detecting that the specific portion of the (n+2)-th member has intruded into the inside of the second region, it is possible to predict that the specific portion is about to execute a motion of intruding into the inside of the first region. It is possible to suppress the error in the related art that occurs when the specific portion of the (n+2)-th member is about to pass the singular point. It is possible to continue work.

In the robot according to the aspect, it is preferable that, in the operation of the manipulator, the specific portion moves on the outside of the first region or on a contour of the first region along the first region.

With this configuration, when changing a scheduled track of the specific portion of the (n+2)-th member, it is possible to reduce an amount of the change.

In the robot according to the aspect, it is preferable that the manipulator stops when the specific portion reaches a contour of the first region.

With this configuration, it is possible to suppress the error in the related art that occurs when the specific portion of the (n+2)-th member is about to pass the singular point.

In the robot according to the aspect, it is preferable that a second region is set on an outside of the first region, operation of the manipulator at a time when the specific portion intrudes into an inside of the second region includes a plurality of operation modes, and, when the specific portion intrudes into the inside of the second region, the manipulator operates on the basis of the operation mode selected in advance out of the plurality of operation modes.

With this configuration, by detecting that the specific portion of the (n+2)-th member has intruded into the inside of the second region, it is possible to predict that the specific portion is about to execute a motion of intruding into the inside of the first region. It is possible to execute appropriate operation according to the selected operation mode.

In the robot according to the aspect, it is preferable that the plurality of operation modes include a first operation mode in which, when the specific portion intrudes into the inside of the second region, the manipulator operates while preventing the specific portion from intruding into the inside of the first region and a second operation mode in which the manipulator stops when the specific portion reaches a contour of the first region.

With this configuration, in the first operation mode, it is possible to suppress the error in the related art that occurs when the specific portion of the (n+2)-th member is about to pass the singular point. It is possible to continue work.

In the second operation mode, it is possible to suppress an error that occurs when the specific portion of the (n+2)-th member is about to pass the singular point.

In the robot according to the aspect, it is preferable that, in the operation of the manipulator in the first operation mode, the specific portion moves on the outside of the first region or on the contour of the first region along the first region.

With this configuration, when changing a scheduled track of the specific portion of the (n+2)-th member, it is possible to reduce an amount of the change.

In the robot according to the aspect, it is preferable that length of the n-th member is larger than length of the (n+1)-th member.

With this configuration, the n-th member and the (n+1) -th member can easily overlap each other when viewed from the axial direction of the (n+1)-th turning axis.

In the robot according to the aspect, it is preferable that the n-th member is provided in the base.

With this configuration, when the robot is set, it is possible to easily perform setting work of the robot by setting the base.

A robot control device according to another aspect of the invention controls the robot according to the aspect.

When the specific portion of the (n+2)-th member is about to pass the singular point, in the related art, an error occurs immediately before the specific portion passes the singular point. The robot urgently stops. On the other hand, in the aspect of the invention, it is possible to suppress an error that occurs when the specific portion of the (n+2)-th member is about to pass the singular point.

It is possible to reduce a space for preventing the robot from interfering with the distal end of the manipulator when the distal end of the manipulator is turned 180° around the n-th turning axis.

A robot system according to still another aspect of the invention includes: the robot according to the aspect; and a robot control device that controls the robot.

When the specific portion of the (n+2)-th member is about to pass the singular point, in the related art, an error occurs immediately before the specific portion passes the singular point. The robot urgently stops. On the other hand, in the aspects of the invention, it is possible to suppress an error that occurs when the specific portion of the (n+2)-th member is about to pass the singular point.

It is possible to reduce a space for preventing the robot from interfering with the distal end of the manipulator when the distal end of the manipulator is turned 180° around the n-th turning axis.

### BRIEF DESCRIPTION OF THE DRAWINGS

The invention will be described with reference to the accompanying drawings, wherein like numbers reference like elements.

FIG. 1 is a perspective view showing a robot system according to an embodiment of the invention.

FIG. 2 is a schematic diagram of the robot system shown in FIG. 1.

FIG. 3 is a side view of the robot system shown in FIG. 1.

FIG. 4 is a front view of the robot system shown in FIG. 1.

FIG. 5 is a front view of the robot system shown in FIG. 1.

FIG. 6 is a block diagram of the robot system shown in FIG. 1.

FIG. 7 is a diagram showing a first region, a second region, and the like in the robot system shown in FIG. 1.

FIG. 8 is a diagram showing the first region, the second region, and the like of the robot system shown in FIG. 1.

FIG. 9 is a flowchart showing a control operation of the robot system shown in FIG. 1.

FIG. 10 is a block diagram showing a simulation device according to an embodiment.

FIG. 11 is a diagram for explaining a simulation of the simulation device shown in FIG. 10.

### DESCRIPTION OF EXEMPLARY EMBODIMENTS

A robot, a robot control device, a robot system, and a simulation device according to embodiments of the invention are explained in detail below with reference to the accompanying drawings.

In the embodiments explained below, an example is explained in which n specified in the appended claims is 1. However, n only has to be an integer equal to or larger than 1.

A robot, a robot control device, and a robot system according to an embodiment

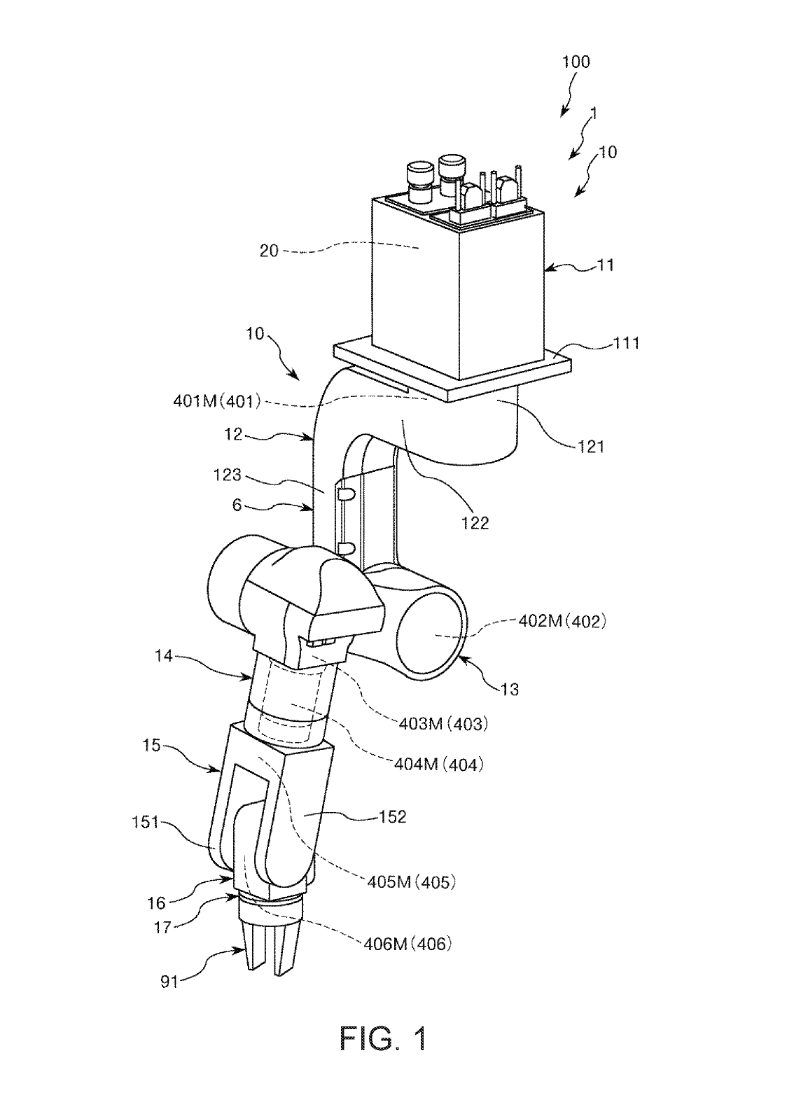

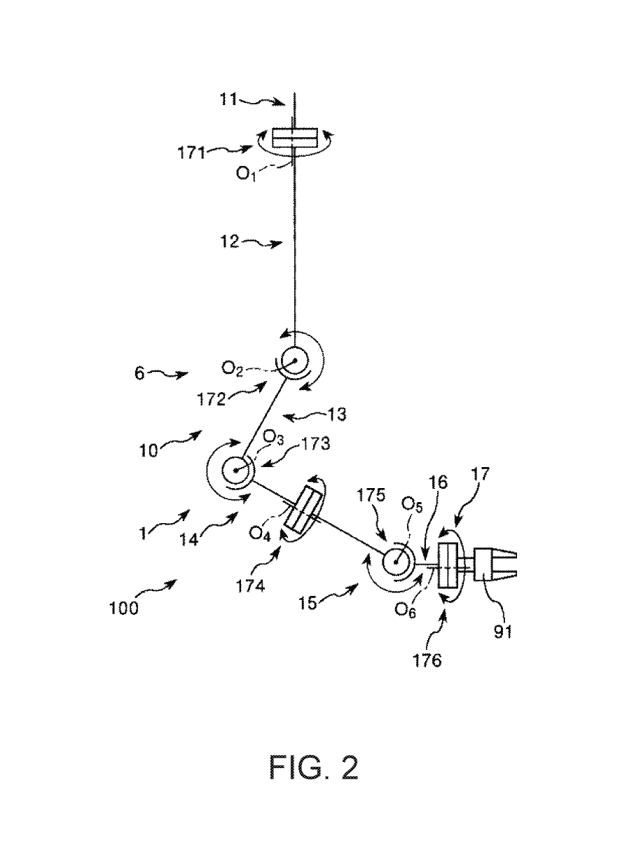

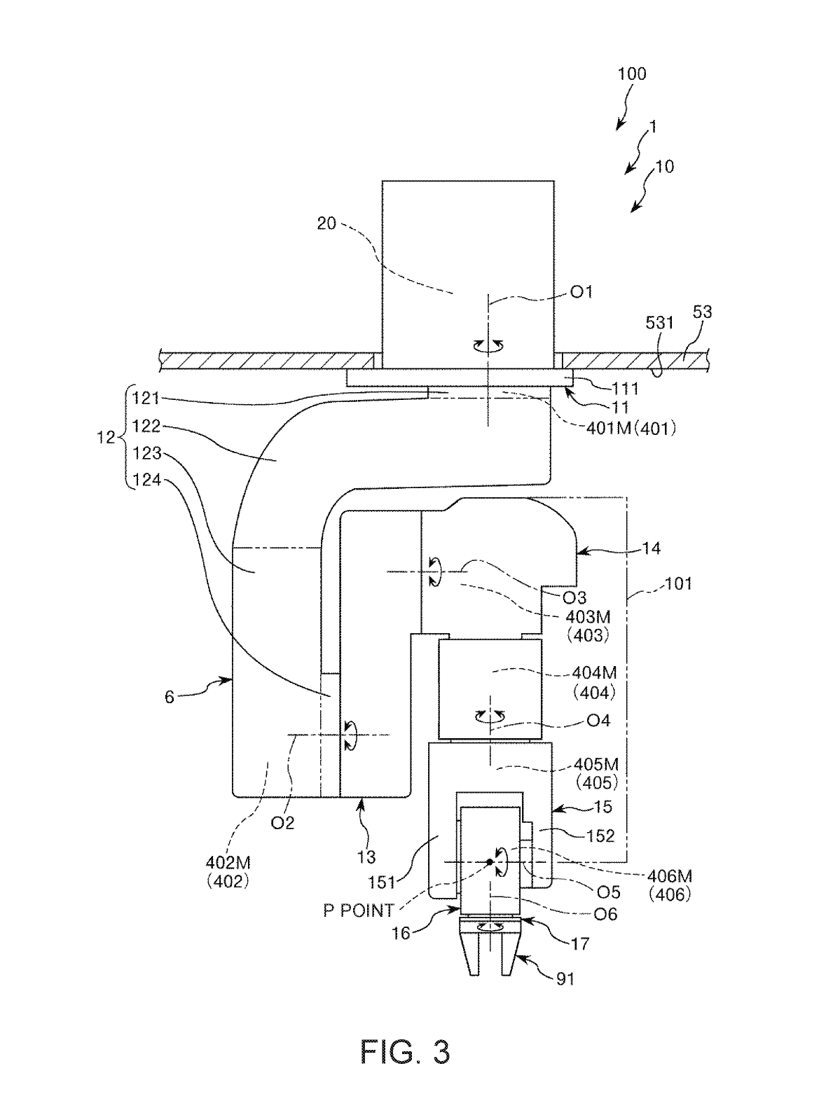

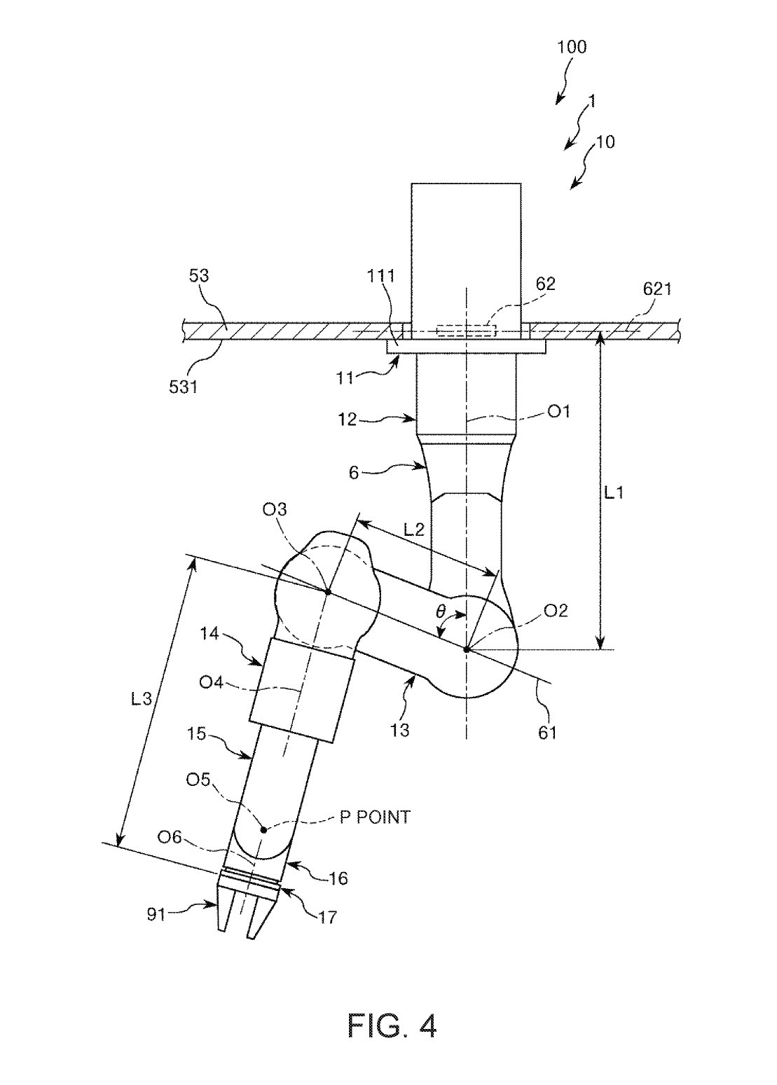

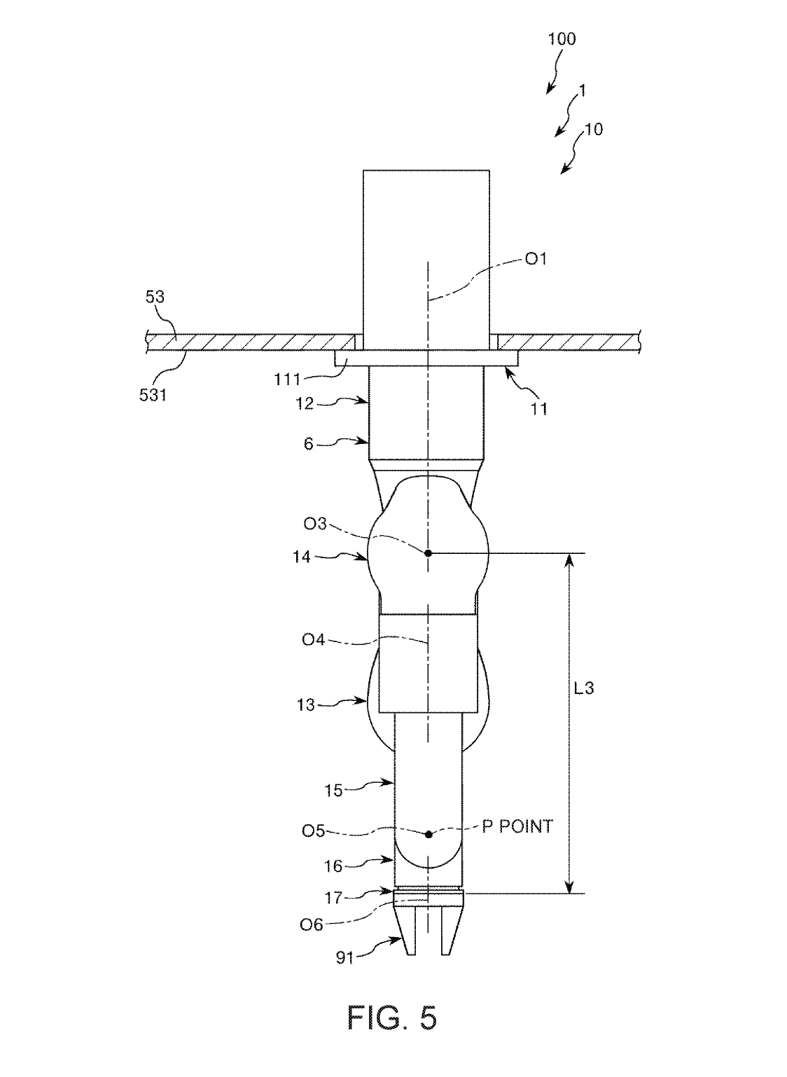

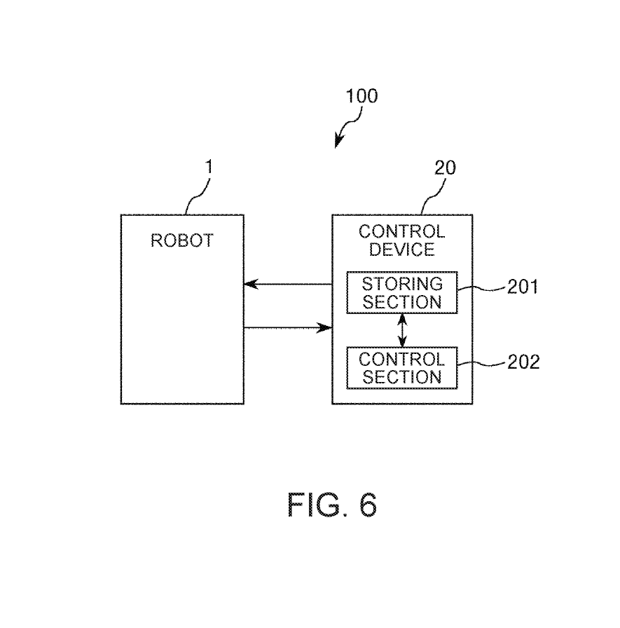

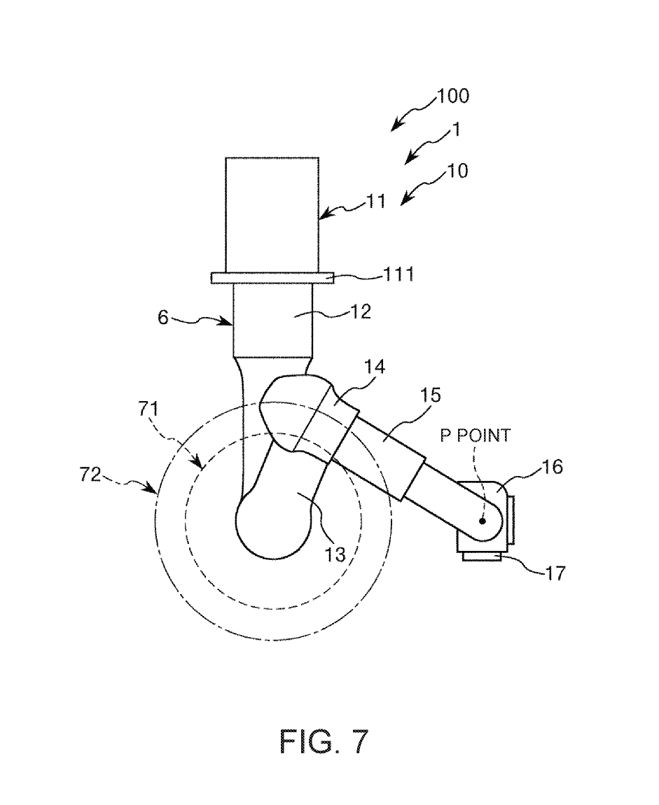

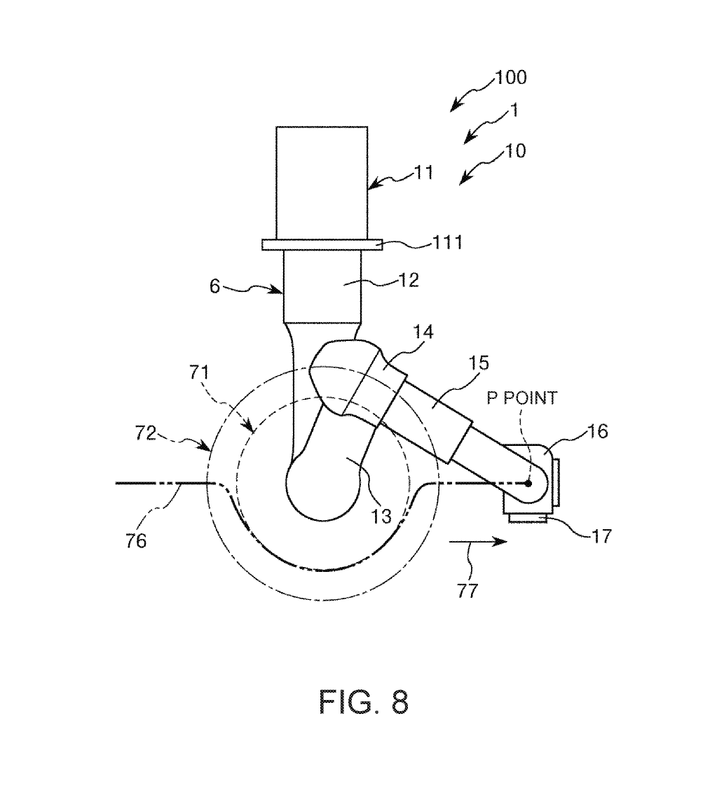

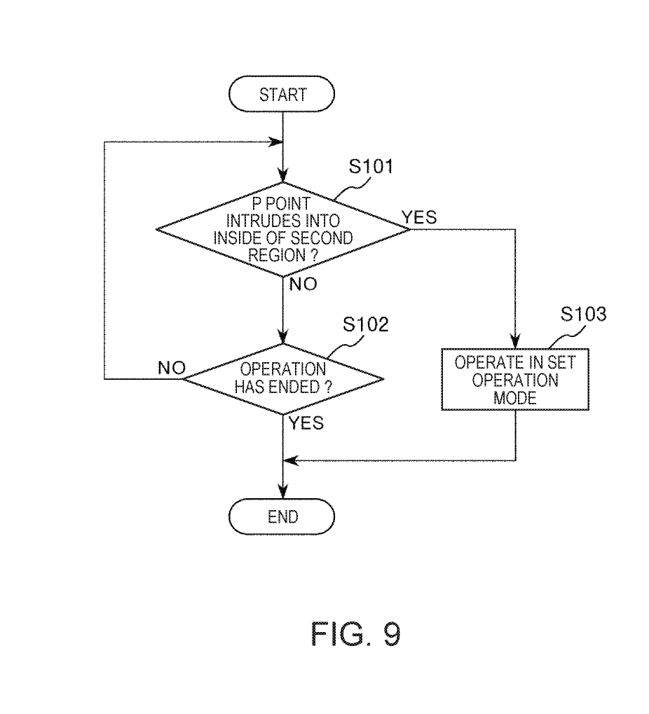

FIG. 1 is a perspective view showing a robot system according to an embodiment of the invention. FIG. 2 is a schematic diagram of the robot system shown in FIG. 1. FIG. 3 is a side view of the robot system shown in FIG. 1. FIG. 4 is a front view of the robot system shown in FIG. 1. FIG. 5 is a front view of the robot system shown in FIG. 1. FIG. 6 is a block diagram of the robot system shown in FIG. 1. FIGS. 7 and 8 are respectively diagrams showing a first region, a second region, and the like in the robot system shown in FIG. 1. FIG. 9 is a flowchart showing a control operation of the robot system shown in FIG. 1.

Note that, in the following explanation, for convenience of explanation, an upper side in FIGS. 1, 3 to 5, 7, and 8 is referred to as “upper” or “upward” and a lower side in the figures is referred to as “lower” or “downward”. Abase side in FIGS. 1 to 5, 7, and 8 is referred to as “proximal end” or “upstream” and the opposite side of the base side (a hand side) is referred to as “distal end” or “downstream”. An up-down direction in FIGS. 1, 3 to 5, 7, and 8 is the vertical direction. In FIGS. 7 and 8, a state in which a hand is detached is illustrated.

As shown in FIGS. 1 to 3 and 7, a robot system 100 (an industrial robot system) includes a robot 1 (an industrial robot) and a control device 20 (a robot control device) that controls the robot 1. The robot system 100 can be used in, for example, a manufacturing process for manufacturing a precision instrument such as a wristwatch. The robot system 100 can perform respective kinds of work such as material supply, material removal, conveyance, and assembly of the precision instrument and components configuring the precision instrument.

The control device 20 includes a control section 202 that performs respective kinds of control and a storing section 201 that stores respective kinds of information. The control device 20 can be configured by a personal computer or the like incorporating a processor (not shown in the figure) or the like. The control device 20 controls sections such as a first motor 401M, a second motor 402M, a third motor 403M, a fourth motor 404M, a fifth motor 405M, and a sixth motor 406M of the robot 1 explained below.

A computer program for controlling the robot 1 is stored in the storing section 201 in advance.

A part of or the entire control device 20 may be incorporated in the robot 1 (a robot main body 10) or may be separate from the robot 1. In this embodiment, the control device 20 is incorporated in a base 11 explained below of the robot 1.

Note that, when the robot 1 and the control device 20 are configured separately from each other, for example, the robot 1 and the control device 20 may be connected by a cable to perform communication in a wired system. Alternatively, the robot 1 and the control device 20 may perform communication in a wireless system without being connected by the cable.

The robot 1 includes the robot main body 10, a first driving source 401, a second driving source 402, a third driving source 403, a fourth driving source 404, a fifth driving source 405, and a sixth driving source 406 (six driving sources). The robot main body 10 includes a base (a supporting section) 11 and a manipulator 6. The manipulator 6 includes a first arm 12, which is an example of a first member, capable turning around a first turning axis O1, a second arm 13, which is an example of a second member, provided in the first arm 12 to be capable of turning around a second turning axis O2 having an axial direction different from an axial direction of the first turning axis O1, and a third member turnably provided in the second arm 13. The third member includes a third arm 14, a fourth arm 15, and a fifth arm 16. Note that a wrist is configured by the fifth arm 16 and a sixth arm 17. An end effector such as a hand 91 can be detachably attached to the distal end of the sixth arm 17. The robot 1 is explained in detail below.

The robot 1 is a vertical multi-joint (six-axis) robot in which the base 11, the first arm 12, the second arm 13, the third arm 14, the fourth arm 15, the fifth arm 16, and the sixth arm 17 are coupled in this order from the proximal end side to the distal end side. Note that, in the following explanation, the first arm 12, the second arm 13, the third arm 14, the fourth arm 15, the fifth arm 16, and the sixth arm 17 are respectively referred to as “arms” as well. The first driving source 401, the second driving source 402, the third driving source 403, the fourth driving source 404, the fifth driving source 405, and the sixth driving source 406 are respectively referred to as “driving sources” as well.

As shown in FIG. 3, the base 11 is a portion fixed (supported) by (a member attached to) a predetermined portion of a setting space. A method for the fixing is not particularly limited. For example, a fixing method by a plurality of bolts may be adopted.

In this embodiment, the base 11 is fixed to a ceiling surface 531 of a ceiling (a ceiling section) 53 of the setting space. The ceiling space 531 is a plane parallel to the horizontal plane. Note that a tabular flange 111 provided at the distal end portion of the base 11 is attached to the ceiling surface 531. However, an attachment part of the base 11 to the ceiling surface 531 is not limited to this.

In the robot 1, a connecting portion of the base 11 and the manipulator 6, that is, a center line (a center) 621 (see FIG. 4) of a bearing section 62 explained below is located further on the vertical direction upper side than the ceiling surface 531. Note that the center line 621 of the bearing section 62 is not limited to this. For example, the center line 621 maybe located further on the vertical direction lower side than the ceiling surface 531 or may be located in a position same as the position of the ceiling surface 531 in the vertical direction.

In the robot 1, since the base 11 is set on the ceiling surface 531, a connecting portion of the first arm 12 and the second arm 13, that is, a center line (a center) of a not-shown bearing section that turnably supports the second arm 13 is located further on the vertical direction lower side than the center line 621 of the bearing section 62.

Note that a joint 171 explained below may be included or may be not included in the base 11 (see FIG. 2).

The first arm 12, the second arm 13, the third arm 14, the fourth arm 15, the fifth arm 16, and the sixth arm 17 are displaceably supported on the base 11 independently from one another.

As shown in FIGS. 1 and 3, the first arm 12 is formed in a bent shape. In a state shown in FIG. 3, the first arm 12 includes a first portion 121 connected to the base 11 and extending to the lower side in FIG. 3 in the axial direction of the first turning axis O1 explained below (the vertical direction) from the base 11, a second portion 122 extending to the left side in FIG. 3 in the axial direction of the second turning axis O2 (the horizontal direction) from the lower end of the first portion 121 in FIG. 3, a third portion 123 provided at the end portion of the second portion 122 on the opposite side of the first portion 121 and extending to the lower side in FIG. 3 in the axial direction of the first turning axis O1 (the vertical direction), and a fourth portion 124 extending to the right side in FIG. 3 in the axial direction of the second turning axis O2 (the horizontal direction) from the end portion of the third portion 123 opposite to the second portion 122. Note that the first portion 121, the second portion 122, the third portion 123, and the fourth portion 124 are integrally formed. The second portion 122 and the third portion 123 are substantially orthogonal to (cross) each other when viewed from a direction orthogonal to both of the first turning axis O1 and the second turning axis O2 (viewed from the near side on the paper surface of FIG. 3).

The second arm 13 is formed in a longitudinal shape and connected to the distal end portion of the first arm 12, that is, the end portion of the fourth portion 124 opposite to the third portion 123.

The third arm 14 is formed in a longitudinal shape and connected to the distal end portion of the second arm 13, that is, the end portion of the second arm 13 opposite to the end portion to which the first arm 12 is connected.

The fourth arm 15 is connected to the distal end portion of the third arm 14, that is, the end portion of the third arm 14 opposite to the end portion to which the second arm 13 is connected. The fourth arm 15 includes a pair of supporting sections 151 and 152 opposed to each other. The supporting section 151 and 152 are used for connection of the fourth arm 15 and the fifth arm 16.

The fifth arm 16 is located between the supporting sections 151 and 152 and connected to the supporting sections 151 and 152 to be coupled to the fourth arm 15. Note that the fourth arm 15 is not limited to this structure and, for example, may include one supporting section (a cantilever).

The sixth arm 17 is formed in a flat shape and connected to the distal end portion of the fifth arm 16. A hand 91 that grips a precision instrument such as a wristwatch, a component, or the like is detachably attached to the distal end portion (the end portion on the opposite side of the fifth arm 16) of the sixth arm 17 as an end effector. Driving of the hand 91 is controlled by the control device 20. Note that the hand 91 is not particularly limited. Examples of the hand 91 include a hand including a plurality of finger sections (fingers). The robot 1 can perform various kinds of work such as conveyance of the precision instrument, the component, or the like by controlling the motions of the arms 12 to 17 and the like while keeping gripping the precision instrument, the component, or the like with the hand 91.

As shown in FIGS. 1 to 3, the first arm 12 is provided on the base 11. Consequently, when the robot 1 is set, it is possible to easily perform setting work of the robot 1 by setting the base 11.

Specifically, the base 11 and the first arm 12 are coupled via a joint 171. The joint 171 includes a mechanism for supporting the first arm 12, which is coupled to the base 11, to be capable of turning with respect to the base 11. Consequently, the first arm 12 is capable of turning with respect to the base 11 about the first turning axis O1 (around the first turning axis O1) parallel to the vertical direction. The first turning axis O1 coincides with the normal of the ceiling surface 531 of the ceiling 53 to which the base 11 is attached. The first turning axis O1 is a turning axis present on the most upstream side of the robot 1. The turning around the first turning axis O1 is performed by driving of the first driving source 401 including the first motor 401M, which is a first driving section (a driving section), and a reduction gear (not shown in the figure).

A turning angle of the first arm 12 is desirably set to 90° or less. Consequently, even when an obstacle is present around the robot 1, the robot 1 can easily operate avoiding the obstacle and can reduce a tact time.

Note that, in the following explanation, the first motor 401M and the second motor 402M, the third motor 403M, the fourth motor 404M, the fifth motor 405M, and the sixth motor 406M explained below are respectively referred to as “motors” as well.

The first arm 12 and the second arm 13 are coupled via a joint 172. The joint 172 includes a mechanism for supporting one of the first arm 12 and the second arm 13, which are coupled to each other, to be capable of turning with respect to the other. Consequently, the second arm 13 is capable of turning with respect to the first arm 12 about the second turning axis O2 (around the second turning axis O2) parallel to the horizontal direction. The second turning axis O2 is orthogonal to the first turning axis O1. The turning around the second turning axis O2 is performed by driving of the second driving source 402 including the second motor 402M, which is a second driving section (a driving section), and a reduction gear (not shown in the figure).

Note that the second turning axis O2 may be parallel to an axis orthogonal to the first turning axis O1. The second turning axis O2 only has to have an axial direction different from the axial direction of the first turning axis O1 even if the second turning axis O2 is not orthogonal to the first turning axis O1.

The second arm 13 and the third arm 14 are coupled via a joint 173. The joint 173 includes a mechanism for supporting one of the second arm 13 and the third arm 14, which are coupled to each other, to be capable of turning with respect to the other. Consequently, the third arm 14 is capable of turning with respect to the second arm 13 about a third turning axis O3 (around the third turning axis O3) parallel to the horizontal direction. The third turning axis O3 is parallel to the second turning axis O2. The turning around the third turning axis O3 is performed by driving of the third driving source 403 including the third motor 403M, which is a third driving section (a driving section), and a reduction gear (not shown in the figure).

The third arm 14 and the fourth arm 15 are coupled via a joint 174. The joint 174 includes a mechanism for supporting one of the third arm 14 and the fourth arm 15, which are coupled to each other, to be capable of turning with respect to the other. Consequently, the fourth arm 15 is capable of turning with respect to the third arm 14 (the base 11) about a fourth turning axis O4 (around the fourth turning axis O4) parallel to the center axis direction of the third arm 14. The fourth turning axis O4 is orthogonal to the third turning axis O3. The turning of the fourth turning axis O4 is performed by driving of the fourth driving source 404 including the fourth motor 404M, which is a fourth driving section (a driving section), and a reduction gear (not shown in the figure).

Note that the fourth turning axis O4 may be parallel to an axis orthogonal to the third turning axis O3. The fourth turning axis O4 only has to have an axial direction different from the axial direction of the third turning axis O3 even if the fourth turning axis O4 is not orthogonal to the third turning axis O3.

The fourth arm 15 and the fifth arm 16 are coupled via a joint 175. The joint 175 includes a mechanism for supporting one of the fourth arm 15 and the fifth arm 16, which are coupled to each other, to be capable of turning with respect to the other. Consequently, the fifth arm 16 is capable of turning with respect to the fourth arm 15 about a fifth turning axis O5 (around the fifth turning axis O5) orthogonal to the center axis direction of the fourth arm 15. The fifth turning axis O5 is orthogonal to the fourth turning axis O4. The turning around the fifth turning axis O5 is performed by driving of the fifth driving source 405. The fifth driving source 405 includes the fifth motor 405M, which is a fifth driving section (a driving section), a reduction gear (not shown in the figure), a first pulley (not shown in the figure) coupled to a shaft section of the fifth motor 405M, a second pulley (not shown in the figure) disposed separately from the first pulley and coupled to a shaft section of the reduction gear, and a belt (not shown in the figure) laid over the first pulley and the second pulley.

Note that the fifth turning axis O5 may be parallel to an axis orthogonal to the fourth turning axis O4. The fifth turning axis O5 only has to have an axial direction different from the axial direction of the fourth turning axis O4 even if the fifth turning axis O5 is not orthogonal to the fourth turning axis O4.

The fifth arm 16 and the sixth arm 17 are coupled via a joint 176. The joint 176 has a mechanism for supporting one of the fifth arm 16 and the sixth arm 17, which are coupled to each other, to be capable of turning with respect to the other. Consequently, the sixth arm 17 is capable of turning with respect to the fifth arm 16 about a sixth turning axis O6 (around the sixth turning axis O6). The sixth turning axis O6 is orthogonal to the fifth turning axis O5. The turning of the sixth turning axis O6 is performed by driving of the sixth driving source 406 including the sixth motor 406M, which is a sixth driving section (a driving section), and a reduction gear (not shown in the figure).

Note that the sixth turning axis O6 may be parallel to an axis orthogonal to the fifth turning axis O5. The sixth turning axis O6 only has to have an axial direction different from the axial direction of the fifth turning axis O5 even if the sixth turning axis O6 is not orthogonal to the fifth turning axis O5.

Note that, in the driving sources 401 to 406, the reduction gears may be respectively omitted. In the arms 12 to 17, brakes (braking devices) for braking the arms 12 to 17 may be respectively provided or omitted.

The motors 401M to 406M are not particularly limited. Examples of the motors 401M to 406M include servo motors such as an AC servo motor and a DC servo motor.

The brakes are not particularly limited. Examples of the brakes include an electromagnetic brake.

In the motors 401M to 406M or the reduction gears of the driving sources 401 to 406, a first encoder, a second encoder, a third encoder, a fourth encoder, a fifth encoder, and a sixth encoder are respectively provided as a first position detecting section that detects the position of the first arm 12, a second position detecting section that detects the position of the second arm 13, a third position detecting section that detects the position of the third arm 14, a fourth position detecting section that detects the position of the fourth arm 15, a fifth position detecting section that detects the position of the fifth arm 16, and a sixth position detecting section that detects the position of the sixth arm 17 (all of the encoders are not shown in the figure). Rotation angles of rotation axes of the motors 401M to 406M or the reduction gears of the driving sources 401 to 406 are respectively detected by the encoders.

The configuration of the robot 1 is simply explained above.

A relation among the first arm 12 to the sixth arm 17 is explained. The relation is explained from various viewpoints by changing expressions and the like. It is assumed that the third arm 14 to the sixth arm 17 are in a state in which the third arm 14 to the sixth arm 17 are stretched straight, that is, a longest state, in other words, a state in which the fourth turning axis O4 and the sixth turning axis O6 coincide with each other or parallel to each other.

As shown in FIG. 4, length L1 of the first arm 12 is longer than length L2 of the second arm 13. Consequently, when viewed from the axial direction of the second turning axis O2, the first arm 12 and the second arm 13 can easily overlap each other.

The length L1 of the first arm 12 is, when viewed from the axial direction of the second turning axis O2, the distance between the second turning axis O2 and the center line 621 extending in the left-right direction in FIG. 4 of the bearing section 62 that turnably supports the first arm 12.

The length L2 of the second arm 13 is the distance between the second turning axis O2 and the third turning axis O3 when viewed from the axial direction of the second turning axis O2.

As shown in FIG. 5, when viewed from the axial direction of the second turning axis O2, the first arm 12 and the second arm 13 are configured to set an angle θ formed by the first arm 12 and the second arm 13 to 0°. That is, when viewed from the axial direction of the second turning axis O2, the first arm 12 and the second arm 13 can overlap each other. That is, the first arm 12 and the second arm 13 are configured to be capable of overlapping each other.

The second arm 13 is configured not to interfere with the ceiling surface 531 of the ceiling 53, on which the base 11 is provided, and the second portion 122 of the first arm 12 when the angle θ is 0°, that is, when the first arm 12 and the second arm 13 overlap each other when viewed from the axial direction of the second turning axis O2. Note that, when the proximal end face of the base 11 is attached to the ceiling surface 531, similarly, the second arm 13 is configured not to interfere with the ceiling surface 531 and the second portion 122 of the first arm 12.

The angle θ formed by the first arm 12 and the second arm 13 is an angle formed by a straight line (a center axis of the second arm 13 viewed from the axial direction of the second turning axis O2) 61, which passes the second turning axis O2 and the third turning axis O3, and the first turning axis O1 when viewed from the axial direction of the second turning axis O2.

By turning the second arm 13 without turning the first arm 12, it is possible to turn the distal end of the second arm 13 180° around the first turning axis O1 through a state in which the angle θ is 0° (a state in which the first arm 12 and the second arm 13 overlap each other) when viewed from the axial direction of the second turning axis O2. That is, by turning the second arm 13 without turning the first arm 12, it is possible to turn the distal end of the manipulator 6 (the distal end of the sixth arm 17) 180° from a left side position shown in FIGS. 1 and 4 to a right side position around the first turning axis O1 (a position on the opposite side of the position shown in FIG. 1 across the first turning axis O1) through the state in which the angle θ is 0° (see FIG. 5). Note that the third arm 14 to the sixth arm 17 are respectively turned according to necessity.

When the distal end of the second arm 13 is turned 180° around the first turning axis O1 (when the distal end of the manipulator 6 is moved from the left side position to the right side position), when viewed from the axial direction of the first turning axis O1, the distal end of the second arm 13 and the distal end of the manipulator 6 move on a straight line.

Total length (maximum length) L3 of the third arm 14 to the sixth arm 17 is set larger than the length L2 of the second arm 13.

Consequently, when viewed from the axial direction of the second turning axis O2, when the second arm 13 and the third arm 14 are superimposed, the distal end of the sixth arm 17 can be projected from the second arm 13. Consequently, it is possible to prevent the hand 91 from interfering with the first arm 12 and the second arm 13.

The total length (the maximum length) L3 of the third arm 14 to the sixth arm 17 is the distance between the third turning axis O3 and the distal end of the sixth arm 17 when viewed from the axial direction of the second turning axis O2 (see FIG. 4). In this case, as shown in FIG. 4, the third arm 14 to the sixth arm 17 are in a state in which the fourth turning axis O4 and the sixth turning axis O6 coincide with each other or are in parallel to each other.

As shown in FIG. 5, the second arm 13 and the third arm 14 are configured to be capable of overlapping each other when viewed from the axial direction of the second turning axis O2.

That is, the first arm 12, the second arm 13, and the third arm 14 are configured to be capable of simultaneously overlapping one another when viewed from the axial direction of the second turning axis O2.

In the robot 1, when the relation explained above is satisfied, by turning the second arm 13 and the third arm 14 without turning the first arm 12, it is possible to turn the hand 91 (the distal end of the sixth arm 17) 180° around the first turning axis O1 through the state in which the angle θ formed by the first arm 12 and the second arm 13 is 0° (a state in which the first arm 12 and the second arm 13 overlap each other) when viewed from the axial direction of the second turning axis O2. It is possible to efficiently drive the robot 1 using this operation. It is possible to reduce the space provided for preventing the robot 1 from interfering with the first arm 12 and the second arm 13. Further, the robot 1 has various advantages explained in the last of this specification.

As shown in FIGS. 7 and 8, in the robot system 100, when the robot 1 performs a predetermined operation (e.g., a CP operation), a specific portion of the third member does not intrude into the inside of a first region 71 including a turning center on the second turning axis O2. That is, the control device 20 controls the robot 1 such that the specific portion does not intrude into the inside of the first region 71. The first region 71 includes a singular point of the manipulator 6 and an immovable region of the manipulator 6. The first region 71 is explained in detail below.

The specific portion can be optionally set in the third member. In this embodiment, the specific portion is set at a P point. The P point is an intersection of the fourth turning axis O4, the fifth turning axis O5, and the sixth turning axis O6. In this embodiment, the fourth turning axis O4 and the sixth turning axis O6 are arranged on the same axis. However, when the fourth turning axis O4 and the sixth turning axis O6 are arranged on different axes, the P point may be an intersection of the fourth turning axis O4 and the fifth turning axis O5 or may be an intersection of the fifth turning axis O5 and the sixth turning axis O6. Note that other examples of the specific portion include the distal end of the fourth arm 15 and the distal end of the fifth arm 16.

The singular point is the position of the specific portion in a singular posture of the manipulator 6, in this embodiment, the position of the P point. In this embodiment, the singular posture of the manipulator 6 is a posture in which the second arm 13 and the third arm 14 are superimposed.

The immovable region of the manipulator 6 is a region into which the specific portion, in this embodiment, the P point cannot intrude because of the structure of the robot 1 (the manipulator 6) irrespective of how the manipulator 6 operates.

The turning center on the second turning axis O2 is a connecting portion of the first arm 12 and the second arm 13 and is a point on the second turning axis O2.

The contour of the first region 71 is a singular region including the singular point. The inside of the first region 71 is the immovable region of the manipulator 6. Note that, in the following explanation, “the immovable region of the manipulator 6” is simply referred to as “immovable region” as well.

By setting the first region 71 in this way, it is possible to predict a motion of the P point passing the singular point (the singular region) and suppress the error in the related art that occurs when the P point is about to pass the singular point. That is, before the error occurs, it is possible to stop the motion of the P point passing the singular point and prevent the error from occurring.

When viewed from the axial direction of the second turning axis O2 (a direction perpendicular to the paper surface of FIG. 4), the contour of the first region 71 (the boundary between the inside and the outside of the first region 71) is a track of the P point at the time when the second arm 13 is turned once around the second turning axis O2 while the singular posture is kept.

Therefore, the shape of the first region 71 is a circle when viewed from the axial direction of the second turning axis O2.

When viewed from a direction perpendicular to the first turning axis O1 and the second turning axis O2 (a direction perpendicular to the paper surface of FIG. 3), the contour of the first region 71 is a track of the P point at the time when the first arm 12 is turned once around the first turning axis O1.

Therefore, when viewed from the direction perpendicular to the first turning axis O1 and the second turning axis O2, the shape of the first region 71 is a circle. That is, the shape of the first region 71 is a sphere.

Consequently, when operating the manipulator 6 while preventing the P point from intruding into the inside of the first region 71, it is possible to smoothly operate the manipulator 6.

A second region 72 is set on the outside of the first region 71. In the operation of the robot 1, when the P point intrudes into the inside of the second region 72, it is assumed that the P point is performing a motion of intruding into the inside of the first region 71, that is, the P point is performing a motion of passing the contour (the singular point) of the first region 71.

The shape of the second region 72 is not particularly limited. However, in this embodiment, when viewed from the axial direction of the second turning axis O2, the shape of the second region 72 is a circle. The center of the circle coincides with the center of the first region 71. In this embodiment, when viewed from the direction perpendicular to the first turning axis O1 and the second turning axis O2, the shape of the second region 72 is a circle. The center of the circle coincides with the center of the first region 71. That is, in this embodiment, the shape of the second region 72 is a sphere. The center of the sphere coincides with the center of the first region 71.

By forming the first region 71 and the second region 72 in the same shape in this way, it is possible to accurately predict a motion of the P point intruding into the inside of the first region 71.

The dimension of the second region 72 is not particularly limited as long as the dimension of the second region 72 is larger than the dimension of the first region 71. The dimension of the second region 72 is set as appropriate according to conditions. The radius of the second region 72 is desirably equal to or larger than 1.1 times and equal to or smaller than 1.5 times of the radius of the first region 71 and more desirably equal to or larger than 1.2 times and equal to or smaller than 1.4 times of the radius of the first region 71.

When the radius of the second region 72 is smaller than the lower limit value, depending on other conditions, it is likely that the motion of the P point passing the singular point cannot be stopped before the error in the related art occurs.

When the radius of the second region 72 is larger than the upper limit value, depending on other conditions, it is likely that a motion of the P point is the motion passing the singular point even if the motion is a motion of the P point not passing the singular point.

That is, by setting the radius of the second region within the range explained above, it is possible to accurately predict the motion of the P point passing the singular point. It is possible to accurately stop, before the error in the related art occurs, the motion of the P point passing the singular point.

Control of the robot 1 by the control device 20 is explained.

The robot 1 and the control device 20 of the robot system 100 include, concerning the operation of the manipulator 6, a plurality of operation modes in which the operation of the manipulator 6 at the time when the P point intrudes into the inside of the second region 72 is different. An operation mode of the manipulator 6 is selected and set out of the plurality of operation modes in advance before the robot 1 operates. When the P point intrudes into the inside of the second region 72, the manipulator 6 operates on the basis of the operation mode selected (set) in advance out of the plurality of operation modes. Consequently, the robot 1 can execute appropriate operation according to the selected operation mode.

The plurality of operation modes include a first operation mode in which, when the P point intrudes into the inside of the second region 72, the manipulator 6 operates while preventing the P point from intruding into the inside of the first region 71 and a second operation mode in which the manipulator 6 stops when the P point reaches the contour of the first region 71. Note that the plurality of operation modes may further include other one or a plurality of operation modes.

Consequently, in the first operation mode, the error in the related art that occurs when the P point is about to pass the singular point does not occur. It is possible to continue work.

In the second operation mode, it is possible to stop the manipulator 6 before an error in that past that occurs when the P point is about to pass the singular point occurs.

If the first operation mode is selected as the operation mode of the manipulator 6, that is, if the operation mode is set in the first operation mode, when the P point intrudes into the inside of the second region 72, the manipulator 6 operates while preventing the P point from intruding into the inside of the first region 71.

Consequently, the error in the related art that occurs when the P point is about to pass the singular point does not occur. It is possible to continue work.

In the operation of the manipulator 6 in the first operation mode, the P point moves on the outside of the first region 71 or on the contour of the first region 71 along the first region 71.

Consequently, in changing a scheduled track of the P point, it is possible to reduce an amount of the change.

As a specific example, when the robot 1 performs a CP operation according to CP control, if the CP operation is set such that the P point moves in a direction of an arrow 77 in FIG. 8 and passes on the second turning axis O2 (see FIG. 4), the track of the P point is changed to a track 76 when the P point intrudes into the inside of the second region 72. The track 76 coincides with the track of the P point of the CP operation when the P point is located on the outside of the second region 72 and on the contour line of the second region 72.

When the P point is located on the inside of the second region 72, the track 76 desirably coincides with the track of the P point of the CP operation or approaches the track of the P point of the CP operation as much as possible. For example, in a place where the track of the P point of the CP operation is located on the inside of the second region 72, the track 76 is desirably located on the contour of the first region 71 as much as possible.

If the second operation mode is selected as the operation mode of the manipulator 6, that is, if the operation mode is set in the second operation mode, that is, if the operation mode is set in the second operation mode, the manipulator 6 stops when the P point reaches the contour of the first region 71.

Consequently, it is possible to stop the manipulator 6 before the error in the related art that occurs when the P point is about to pass the singular point occurs.

The control operation of the robot 1 by the control device 20 is briefly summarized below. As shown in FIG. 9, in the operation of the robot 1, first, the control device 20 determines whether the P point has intruded into the inside of the second region 72 (step S101).

When determining in step S101 that the P point has not intruded into the inside of the second region 72, the control device 20 determines whether the operation has ended (step S102). When determining in step S102 that the operation has not ended, the control device 20 returns to step S101 and executes step S101 and subsequent steps again. When determining in step S102 that the operation has ended, the control device 20 ends the control.

When determining in step S101 that the P point has intruded into the inside of the second region 72, as explained above, the control device 20 performs operation in the set operation mode of the first operation mode and the second operation mode (step S101). When the operation ends, the control device 20 ends the control.

As explained above, with the robot system 100, when the robot 1 performs predetermined work, the P point is controlled not to intrude into the inside of the first region 71. Consequently, it is possible to prevent the robot 1 from suspending work because of an unexpected error or the like.

That is, in the related art, when the P point is about to pass the singular point, an error occurs immediately before the P point passes the singular point. The robot urgently stops. On the other hand, in the robot system 100, it is possible to predict a motion of the P point passing the singular point, that is, a motion of the P point passing the contour of the first region 71 and suppress the error. That is, before the error occurs, it is possible to stop the motion of the P point passing the contour of the first region 71 and prevent the error from occurring. Consequently, the error does not occur. It is possible to perform the CP operation as much as possible.

As explained above, in the robot system 100, by turning the second arm 13, the third arm 14, and the like without turning the first arm 12, it is possible to turn the distal end of the manipulator 6 180° around the first turning axis O1 through the state in which the angle θ formed by the first arm 12 and the second arm 13 is 0° (the state in which the first arm 12 and the second arm 13 overlap each other) when viewed from the axial direction of the second turning axis O2.

Consequently, it is possible to reduce a space for preventing the robot 1 from interfering with the first arm 12 and the second arm 13.

That is, first, it is possible to lower the ceiling 53. Consequently, the position of the center of gravity of the robot 1 lowers. It is possible to reduce the influence of vibration of the robot 1. That is, it is possible to suppress vibration caused by reaction due to the operation of the robot 1.

It is possible to reduce an operation region in the width direction of the robot 1 (a direction of a production line). Consequently, it is possible to arrange many robots 1 per unit length along the production line. It is possible to reduce the production line in length.

When moving the distal end of the manipulator 6, it is possible to reduce a movement of the robot 1. For example, it is possible not to turn the first arm 12 or it is possible to reduce a turning angle of the first arm 12. Consequently, it is possible to reduce a tact time. It is possible to improve work efficiency.

When it is attempted to simply turn the first arm 12 around the first turning axis O1 as in the robot of the related art and execute a motion for turning the distal end of the manipulator 6 180° around the first turning axis O1 (hereinafter referred to as “shortcut motion” as well), it is likely that the robot 1 interferes with a wall (not shown in the figure) or a peripheral device (not shown in the figure) near the robot 1. Therefore, it is necessary to teach the robot 1 about a retraction point for avoiding the interference. For example, if the robot 1 interferes with the wall when only the first arm 12 is turned 90° around the first turning axis O1, it is necessary to teach, by turning the other arms, the robot 1 about a retraction point such that the robot 1 does not interfere with the wall. Similarly, if the robot 1 interferes with the peripheral device as well, it is necessary to further teach the robot 1 about a retraction point such that the robot 1 does not interfere with the peripheral device. In this way, in the robot of the related art, it is necessary to teach the robot about a large number of retraction points. In particular, when a space around the robot 1 is small, an enormous number of retraction points are necessary. A lot of labor and a long time are required for the teaching.

On the other hand, in the robot system 100, when the shortcut motion is executed, the numbers of regions and portions that the robot 1 is likely to interfere are extremely small. Therefore, it is possible to reduce the number of retraction points to be taught. It is possible to reduce the labor and the time required for the teaching. That is, in the robot system 100, the number of retraction points to be taught is, for example, approximately ⅓ of the number of retraction points of the robot of the related art. The teaching is dramatically facilitated.

A region (a portion) 101 surrounded by an alternate long and two short dashes line on the right side in FIG. 3 of the third arm 14 and the fourth arm 15 is a region (a portion) 101 where the robot 1 does not interfere with or less easily interferes with the robot 1 itself and other members. Therefore, when a predetermined member is mounted in the region 101, the member less easily interfere with the robot 1, the peripheral device, and the like. Therefore, in the robot system 100, it is possible to mount the predetermined member in the region 101. In particular, when the predetermined member is mounted in a region on the right side in FIG. 3 of the third arm 14 in the region 101, a probability of interference of the member with the peripheral device (not shown in the figure) disposed on a not-shown workbench is lower. Therefore, the region 101 is more effective.

Examples of members that can be mounted in the region 101 include a control device that controls driving of sensors of a hand, a hand eye camera, and the like and an electromagnetic valve of an attracting mechanism.

As a specific example, for example, when the attracting mechanism is provided in the hand, if the electromagnetic valve or the like is set in the region 101, the electromagnetic valve does not obstruct driving of the robot 1. In this way, the region 101 has high convenience. Simulation device according to an embodiment

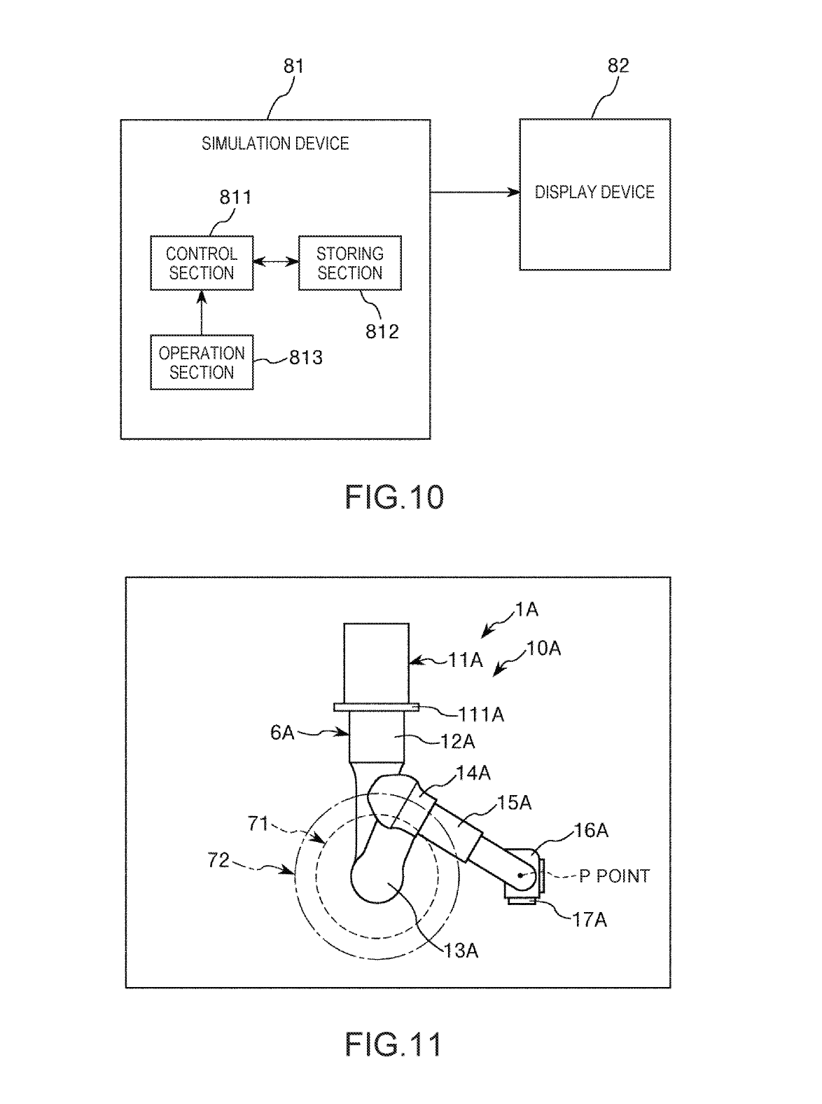

FIG. 10 is a block diagram showing a simulation device according to an embodiment. FIG. 11 is a diagram for explaining a simulation of the simulation device shown in FIG. 10.

In the following explanation, concerning this embodiment, differences from the embodiment explained above are mainly explained. Concerning the same matters, explanation is omitted.

As shown in FIG. 10, a simulation device 81 includes a control section 811 that performs respective kinds of control, a storing section 812 that stores respective kinds of information, and an operation section 813 that performs respective kinds of operation. The simulation device 81 is a device that performs a simulation of the operation of a virtual robot 1A on a virtual space. A dimension of the virtual space is not particularly limited. Examples of the dimension include two dimensions and three dimensions. Note that the control device 20 controls the actual robot 1 on the basis of a simulation result of the simulation by the simulation device 81.

Signs of respective sections of the virtual robot 1A are respectively added with “A” after the signs of the corresponding sections of the actual robot 1 explained above.

Names of the sections of the virtual robot 1A are respectively written by adding “virtual” before the names of the corresponding sections of the robot 1. The virtual robot 1A is the same as the robot 1. Therefore, explanation of the virtual robot 1A is omitted.

A display device 82 capable of displaying images such as an image indicating a simulation is connected to the simulation device 81. A simulation system is configured by the simulation device 81 and the display device 82. Note that the simulation device 81 may include a display device (a display section) instead of the display device 82. The simulation device 81 may include a display device separately from the display device 82.

In a simulation, the simulation device 81 performs, on the virtual robot 1A, control same as the control performed on the robot 1. In the simulation, as shown in FIG. 11, the simulation device 81 displays, with the display device 82, an image indicating the simulation, that is, the virtual robot 1A, the first region 71, and the second region 72 on the virtual space.

The first region 71 and the second region 72 are respectively displayed to be distinguishable from each other.

The first region 71 and the second region 72 may be respectively displayed in any forms. Specific examples of the forms include a form in which only contours of the first region 71 and the second region 72 are displayed and a form in which the entire first region 71 and the entire second region 72 are displayed.

Specific examples of the display capable of distinguishing the first region 71 and the second region 72 include a configuration in which the first region 71 and the second region 72 are displayed in colors different from each other and a configuration in which portions of the contours of the first region 71 and the second region 72 are displayed as different lines, for example, one of the contours is displayed as a broken line and the other is displayed as an alternate long and short dash line.

When the entire first region 71 and the entire second region 72 are displayed, it is desirable to respectively display the first region 71 and the second region 72 translucently. Consequently, even if the entire first region 71 and the entire second region 72 are displayed, it is possible to easily visually recognize the robot 1 located on the insides of the first region 71 and the second region 72.

The translucent does not means that transparency is a half of complete transparency and means that the first region 71 and the second region 72 have transparence for enabling visual recognition of the insides of the first region 71 and the second region 72. Complete transparence that does not enable visual recognition of the first region 71 itself and the second region 72 itself is excluded.

As explained above, with the simulation device 81, in the simulation, when the virtual robot 1A performs a predetermined operation, the virtual robot 1A is controlled such that the P point does not intrude into the inside of the first region 71. Consequently, it is possible to prevent the simulation from being suspended by an unexpected error or the like.

Note that, in this embodiment, the display device 82 is configured to display the first region 71 and the second region 72. However, the display device 82 is not limited to this and may be configured to display, for example, either one of the first region 71 and the second region 72. As another configuration example, the simulation device 81 may have a first display mode in which only the first region 71 of the first region 71 and the second region 72 is displayed, a second display mode in which only the second region 72 is displayed, and a third display mode in which the first region 71 and the second region 72 are displayed.

The display device 82 may be configured to display the track 76 and the like referred to in the explanation of the robot system 100.

The robot, the robot control device, the robot system, and the simulation device according to the embodiments are explained above with reference to the drawings. However, the invention is not limited to this. The components of the sections can be substituted with any components having the same functions. Any other components may be added.

In the embodiment, n is 1 as specified in the appended claims. However, in the invention, n is not limited to this and is an integer equal to or larger than 1. That is, in the invention, when n is the integer equal to or lager than 1, the robot, the robot control device, the robot system, and the simulation device only have to be configured the same as when n is 1.

In the embodiments, the number of turning axes of the manipulator (the robot arm) is six. However, in the invention, the number of turning axes is not limited to this. The number of turning axes of the manipulator may be, for example, three, four, five, or seven or more. That is, in the embodiments, the number of arms (links) is six. However, in the invention, the number of arms is not limited to this. The number of arms may be three, four, five, or seven or more. For example, a robot including seven arms can be realized by adding an arm between the second arm and the third arm in the robot in the embodiments.

In the embodiments, the number of manipulators is one. However, in the invention, the number of manipulators is not limited to this. The number of manipulators may be, for example, two or more. That is, the robot (the robot main body) may be a multi-arm robot such as a double-arm robot.

In the embodiments, the hand is explained as the example of the end effector. However, in the invention, the end effector is not limited to this. Besides, examples of the end effector include a drill, a welder, and a laser irradiator.

In the embodiments, the fixing part of base of the robot is the ceiling. However, in the invention, the fixing part is not limited to this. Besides, examples of the fixing part include a floor, a wall, a workbench, and a ground in the setting space. The robot may be set in a cell. In this case, the fixing part of the base is not particularly limited. Examples of the fixing part include a ceiling section, a wall section, a workbench, and a floor of the cell.

In the embodiments, the surface on which the robot (the base) is fixed is the plane (the surface) parallel to the horizontal plane. However, in the invention, the surface is not limited to this. For example, the surface may be a plane (a surface) inclined with respect to the horizontal plane or the vertical plane or may be a plane (a surface) parallel to the vertical plane. That is, the first turning axis may be inclined with respect to the vertical direction or the horizontal direction or may be parallel to the horizontal direction.

In the invention, the robot maybe a robot of another form. Specific examples of the robot include a legged walking (running) robot including leg sections.

In the embodiments, the control device of the robot and the simulation device are the separate devices. However, in the invention, the control device and the simulation device are not limited to this. For example, the control device of the robot may have the function of the simulation device.

The entire disclosure of Japanese Patent Application No. 2016-129171, filed Jun. 29, 2016 is expressly incorporated by reference herein.

What is claimed is:

1. A robot comprising a manipulator including an n (n is an integer equal to or larger than 1)-th member capable of turning around an n-th turning axis, an (n+1)-th member provided in the n-th member to be capable of turning around an (n+1)-th turning axis having an axial direction different from an axial direction of the n-th turning axis, and an (n+2)-th member turnably provided in the (n+1)-th member, wherein
the n-th member and the (n+1)-th member are capable of overlapping each other when viewed from an axial direction of the (n+1)-th turning axis,
a specific portion of the (n+2)-th member does not intrude into an inside of a first region including a turning center on the (n+1)-th turning axis, and
the first region includes a singular point of the manipulator and an immovable region of the manipulator.

2. The robot according to claim 1, wherein a shape of the first region is a circle when viewed from the axial direction of the (n+1)-th turning axis.

3. The robot according to claim 1, wherein a contour of the first region is a singular region including the singular point.

4. The robot according to claim 1, wherein the inside of the first region is the immovable region.

5. The robot according to claim 1, wherein
a second region is set on an outside of the first region, and
when the specific portion intrudes into an inside of the second region, the manipulator operates while preventing the specific portion from intruding into the inside of the first region.

6. The robot according to claim 5, wherein, in the operation of the manipulator, the specific portion moves on the outside of the first region or on a contour of the first region along the first region.

7. The robot according to claim 1, wherein the manipulator stops when the specific portion reaches a contour of the first region.

8. The robot according to claim 1, wherein
a second region is set on an outside of the first region,
operation of the manipulator at a time when the specific portion intrudes into an inside of the second region includes a plurality of operation modes, and
when the specific portion intrudes into the inside of the second region, the manipulator operates on the basis of the operation mode selected in advance out of the plurality of operation modes.

9. The robot according to claim 8, wherein the plurality of operation modes include a first operation mode in which, when the specific portion intrudes into the inside of the second region, the manipulator operates while preventing the specific portion from intruding into the inside of the first region and a second operation mode in which the manipulator stops when the specific portion reaches a contour of the first region.

10. The robot according to claim 9, wherein, in the operation of the manipulator in the first operation mode, the specific portion moves on the outside of the first region or on the contour of the first region along the first region.

11. The robot according to claim 1, wherein length of the n-th member is larger than length of the (n+1)-th member.

12. The robot according to claim 1, wherein the n-th member is provided in the base.

13. A robot control device that controls the robot according to claim 1.

14. A robot control device that controls the robot according to claim 2.

15. A robot control device that controls the robot according to claim 3.

16. A robot control device that controls the robot according to claim 4.

17. A robot system comprising:
the robot according to claim 1; and
a robot control device that controls the robot.

18. A robot system comprising:
the robot according to claim 2; and
a robot control device that controls the robot.

19. A robot system comprising:
the robot according to claim 3; and
a robot control device that controls the robot.

20. A robot system comprising:
the robot according to claim 4; and
a robot control device that controls the robot.
